(19) United States
(12) Patent Application Publication
(10) Pub. No.: US 2009/0104359 A1
(43) Pub. Date: Apr. 23, 2009

(54) Stranding machine and method of coating stranded wire

(75) Inventor: Yoshikazu Iwasaki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Bridgestone Corporation, Chuo-ku (JP)

(21) Appl. No.: 11/918,454

(22) PCT Filed: Apr. 14, 2006
(86) PCT No.: PCT/JP2006/307942

§ 371 Date: Oct. 15, 2007

(30) Foreign Application Priority Data
Apr. 14, 2005 (JP) 2005-117253

(51) Int. Cl. B05D 3/12; B05C 11/02

(52) U.S. Cl. 427/355; 118/100

(57) ABSTRACT

In the stranding machine 22, a rotating force about a wire material drawing direction (X-direction) is applied to a plurality of wire materials 18A to 18C drawn from bobbins 14A to 14C by rotation of a rotating body 30 arranged on a position apart from the bobbins 14A to 14C in the wire material drawing direction (X-direction), so that a stranded wire is formed. Therefore, the plurality of wire materials 18A to 18C does not rotate in the bobbins 14A to 14C at a stranded point 26 of the plurality of wire materials 18A to 18C. As a result, when the plurality of wire materials 18A to 18C is coated with unvulcanized rubber 88 in the rubber coating section 28, the plurality of wire materials 18A to 18C does not cross the inside of the unvulcanized rubber. For this reason, the unvulcanized rubber 88 sufficiently fills spaces between the plurality of wire materials 88, and sufficiently adheres to the surface of each of the wire materials 18A to 18C.

### TECHNICAL FIELD

The present invention relates to a stranding machine and a method of coating a stranded wire, and particularly relates to the stranding machine and the method of coating a stranded wire which coat a stranded wire.

### BACKGROUND ART

Conventionally, a stranding machine and a method of coating a stranded wire which coat a stranded wire are known (for example, see Patent Document 1). Such a stranding machine and a method of coating a stranded wire are described below by exemplifying a process of manufacturing a stranded rubber-coated steel cord to be used for air tires of vehicles.

Patent Document 1 describes an example of a cord manufacturing apparatus. This cord manufacturing apparatus strands a plurality of steel cords and coats them with rubber so as to form a stranded rubber-coated steel cord. The cord manufacturing apparatus is provided with a tubular type stranding machine, a preformer, a rubber extruding machine, and a tension applying apparatus.

The tubular type stranding machine has a rotating barrel and an electric motor which drives to rotate the rotating barrel. Three bobbins around which steel cords are wound, respectively, are arranged on the rotating barrel. The preformer is provided to a front end surface of the rotating barrel so as to rotate integrally with the rotating barrel, and the preformer forms a spire of a predetermined pitch on the respective steel cords so as to make the stranding easy. The rubber extruding machine has an extrusion mold head which strands the steel cords and simultaneously extrudes rubber, and an extruding machine main body which pressure-supplies unvulcanized rubber to the head.

The extruding mold head is configured of an extruding mold main body, a stranding maintaining tool, a stranding die, and an extrusion chamber. The tension applying apparatus rotates a winding drum at a predetermined speed, wounds the stranded rubber-coated cord unreeled from the extruding mold head, and applies predetermined tension to the respective steel cords passing through the preformer and the extruding mold head.

In the cord manufacturing apparatus in Patent Document 1 having the above constitution, when the tension applying apparatus applies a constant winding tension, the steel cords are drawn from the three bobbins of the rotating barrel. The steel cords drawn from the bobbins are led from a shaft center of the rotating barrel to an externally radial direction, and are guided to a longitudinal direction of the rotating barrel so as to be sent from a delivery orifice opened on the front end surface of the rotating barrel to the preformer.

The three steel cords which pass through the preformer assemble towards a rotating axis line of the rotating barrel and are led into the extruding mold head of the rubber extruding machine. The three steel cords led into the extruding mold head pass through three separation passing holes of the stranding maintaining tool and are guided to a separation passing groove and are led into a rubber injection section so as to pass through the die. At this time, in the extrusion chamber, an atmosphere filled with the compression-transported unvulcanized rubber is formed, and the steel cords are stranded in this atmosphere. That is to say, in the atmosphere filled with the compression-transported unvulcanized rubber, a plurality of steel cords rotate about its delivery direction.

A gap portion of the axial center of the stranded wire consisted of the three steel cords stranded and passing through the rubber injection section is filled with the steel cords with the steel cords being wound in. At the same time, an outer peripheral surface of the stranded wire is coated with the unvulcanized rubber so that a stranded rubber-coated steel cord is formed.

### Patent Document 1: Japanese Patent Application Laid-Open No. 2004-277923 (FIGS. 1 to 5)

### DISCLOSURE OF THE INVENTION

### Problem to be Solved by the Invention

However, in the example in Patent Document 1, the plurality of steel codes rotate about their delivery direction in the atmosphere filled with the compression-transported unvulcanized rubber. Therefore, since the plurality of steel cords cross the unvulcanized rubber which is compression-transported and filled, it is difficult that the rubber adheres to the surfaces of the steel cords and the rubber enter between the plurality of steel cords (difficult to fill). As a result, the stranded wire might be insufficiently coated with the rubber. In order to sufficiently coat the surface of the steel cords with the rubber, in the constitution in Patent Document 1, it is considered that after the plurality of steel cords are stranded so as to become the stranded wire, the stranded wire is allowed to pass through the atmosphere filled with the compression-transported unvulcanized rubber.

However, in the example in Patent Document 1, after the plurality of steel cords are stranded so as to become the stranded wire, the stranded wire does not rotate and is drawn directly. Therefore, even if the stranded wire does not rotate and passes directly through the atmosphere filled with the compression-transported unvulcanized rubber, the rubber does not sufficiently enter a concave portion of a spiral convex-concave portion formed on the surface of the stranded wire, and the stranded wire might be, then, insufficiently coated with the rubber. It is not desirable for solving the above defects to enlarge the stranding machine, and when the stranding machine which solves the above defects is constituted, the stranding machine is desirably compact.

The invention is devised in view of the above circumstances, and its object is to provide a stranding machine and a method of coating a stranded wire which can form a stranded wire sufficiently coated with rubber.

Further, it is another object of the invention to provide a compact stranding machine.

### Means for Solving the Problem

In order to solve the above problem, the stranding machine of claim 1 is characterized by including: a wire material drawing unit which draws a plurality of wire materials from a wire material holding unit which holds the plurality of wire materials; a stranded wire forming unit which is disposed at a position apart from the wire material holding unit in a wire material drawing direction of the plurality of wire materials, and which rotates about the wire material drawing direction so as to apply a rotating force having a rotating axis in the wire material drawing direction of the plurality of wire materials, and which strands the plurality of wire materials so as to form a stranded wire; and a coating unit which coats at least one of the plurality of wire materials positioned on the wire material holding unit side of a stranded point of the plurality of wire materials, and the stranded wire positioned on a stranded wire rotating unit side of the stranded point.

A function of the stranding machine of claim 1 is described below.

In the stranding machine of claim 1, the wire material drawing unit draws a plurality of wire materials from the wire material holding unit. The rotating force having a rotating axis in the wire material drawing direction is applied to the plurality of wire materials drawn from the wire material holding unit, by rotation of the stranded wire forming unit disposed at a position apart from the wire material holding unit, in the drawing direction of the plurality of wire materials. As a result, the plurality of wire materials is stranded so that a stranded wire is formed. At this time, the coating unit coats with coating material at least one of the plurality of wire materials positioned on the wire material holding unit side of the stranded point of the plurality of wire materials, and the stranded wire positioned on the stranded wire rotating unit side of the stranded point. As a result, a coated stranded wire is formed.

In the stranding machine of claim 1, the rotating force having a rotating axis in the wire material drawing direction is applied to the plurality of wire materials drawn from the wire material holding unit by the rotation of the stranded wire forming unit disposed at a position apart from the wire material holding unit, in the wire material drawing direction of the plurality of wire materials. Therefore, on the wire material holding unit side of the stranded point of the plurality of wire materials, the plurality of wire materials does not rotate, and on the stranded wire forming unit side of the stranded point of the plurality of wire materials, the stranded wire rotates.

In the stranding machine of claim 1, the plurality of wire materials does not rotate on the wire material holding unit side of the stranded point of the plurality of wire materials. Therefore, when the coating unit coats the plurality of wire materials with a coating material, since the plurality of wire materials does not cross the inside of the coating material, the coating material sufficiently fills spaces between the plurality of wire materials, and the coating materials sufficiently adheres to the surface of each of the wire materials. As a result, a sufficiently coated stranded wire can be formed.

In the stranding machine of claim 1, the stranded wire rotates on the stranded wire forming unit side of the stranded point of the plurality of wire materials. Therefore, when the coating unit coats the stranded wire with the coating material, since the stranded wire rotates in the coating material, the coating material sufficiently enters a concave portion of a spiral convex-concave portion that forms on the surface of the stranded wire due to a twisting action. As a result, a sufficiently coated stranded wire can be formed.

At this time, the plurality of wire materials positioned on the wire material holding unit side of the stranded point is coated, and even after the plurality of coated wire materials is stranded so that the stranded wire is formed, the stranded wire is subsequently coated with the coating material. As a result, a sufficiently coated stranded wire can be reliably formed.

The stranding machine of claim 2 is characterized in that the wire material drawing unit is provided to the stranded wire forming unit in the stranding machine of claim 1.

A function of the stranding machine of claim 2 is described below.

In the stranding machine of claim 2, the wire material drawing unit is provided to the stranded wire forming unit. Therefore, since the stranded wire forming unit and the wire material drawing unit can be integrated, the stranding machine can be compact.

The stranding machine of claim 3 is characterized in that a smoothing unit which smoothes the coating material on the surface of the stranded wire is provided in the wire material drawing direction of the coating unit in the stranding machine of claim 1 or 2.

A function of the stranding machine of claim 3 is described below.

In the stranding machine of claim 3, the smoothing unit which smoothes the coating material on the surface of the stranded wire is provided in the wire material drawing direction of the coating unit. Therefore, even when the coating unit coats the surface of a stranded wire with the coating material, the coating material on the surface of the stranded wire can be smoothed by the smoothing unit. Therefore, because it is possible to smooth convexities, concavities, and coating irregularities in the coating material coated on the surface of the stranded wire, a stranded wire sufficiently provided with coating material can be formed.

The method of coating a stranded wire of claim 4 is characterized in that a plurality of wire materials is drawn from a wire material holding unit for holding the plurality of wire materials, and a rotating force, having a rotating axis in a wire material drawing direction, is applied to the plurality of wire materials, at a position apart from the wire material holding unit in the wire material drawing direction of the plurality of wire materials, and the plurality of wire materials is stranded so that a stranded wire is formed, wherein at least one of the plurality of wire materials positioned on the wire material holding unit side of a stranded point of the plurality of wire materials, and the stranded wire positioned on the side of the stranded point opposite to the wire material holding unit, are coated with a coating material.

A function of the method of coating a stranded wire of claim 4 is described below.

In the method of coating a stranded wire of claim 4, the plurality of wire materials is drawn from the wire material holding unit which holds the plurality of wire materials, the rotating force having a rotating axis in the wire material drawing direction is applied to the plurality of wire material on the position apart from the wire material holding unit in the wire material drawing direction of the plurality of wire materials, and the plurality of wire materials is stranded so that the stranded wire is formed. In the method of coating a stranded wire of claim 4, at least one of the plurality of wire materials positioned on the wire material holding unit side of the stranded point of the plurality of wire materials and the stranded wire positioned on a side of the stranded point opposite to the wire material holding unit are coated with the coating material.

In the method of coating a stranded wire of claim 4, the rotating force having a rotating axis in the wire material drawing direction is applied to the plurality of wire materials drawn from the wire material holding unit on the position apart from the wire material holding unit in the drawing direction of the plurality of wire materials so that a stranded wire is formed. Therefore, the plurality of wire materials does not rotate on the wire material holding unit side of the stranded point of the plurality of wire materials, and the stranded wire rotates on the side of the stranded point of the plurality of wire materials opposite to the wire material holding unit. In the method of coating a stranded wire of claim 4, the plurality of wire materials does not rotate on the wire material holding unit side of the stranded point of the plurality of wire materials. Therefore, when the plurality of wire materials is coated with the coating material, since the plurality of wire materials does not cross the inside of the coating material, the coating material sufficiently fills spaces between the plurality of wire materials and the coating material sufficiently adheres to the surface of each of the wire materials. As a result, the sufficiently coated stranded wire can be formed.

In the method of coating a stranded wire of claim 4, the stranded wire rotates on the side of the stranded point of the plurality of wire materials opposite to the wire material holding unit. Therefore, when the stranded wire is coated with the coating material, since the stranded wire rotates in the coating material, the coating material sufficiently enters a concave portion of a spiral convex-concave portion formed on the surface of the stranded wire due to a thread function. As a result, the sufficiently coated stranded wire can be formed. At this time, the plurality of wire materials positioned on the wire material holding unit side of the stranded point is coated, and after the plurality of coated wire materials is stranded so that the stranded wire is formed, the stranded wire is subsequently coated with the coating material. As a result, the sufficiently coated stranded wire can be reliably formed.

The method of coating a stranded wire of claim 5 depending from claim 4, is characterized in that after at least one of the plurality of wire materials positioned on the wire material holding unit side of the stranded point of the plurality of wire materials and the stranded wire positioned on the side of the stranded point opposite to the wire material holding unit is coated with the coating material, the coating material on the surface of the stranded wire is smoothed.

A function of the method of coating a stranded wire of claim 5 is described below.

In the method of coating a stranded wire of claim 5, after at least one of the plurality of wire materials positioned on the wire material holding unit side of the stranded point of the plurality of wire materials and the stranded wire positioned on the side of the stranded point opposite to the wire material holding unit is coated with the coating material, the coating material on the surface of the stranded wire is smoothed. Therefore, because it is possible to smooth convexities, concavities, and coating irregularities in the coating material coated on the surface of the stranded wire, a stranded wire sufficiently provided with coating material can be formed.

### Effect of the Invention

As described above in detail, according to the present invention, when the plurality of wire materials is coated with the coating material, since the plurality of wire materials does not cross the inside of the coating material, the coating material sufficiently fills spaces between the plurality of wire materials and sufficiently adheres to the surface of the coating materials. As a result, the sufficiently coated stranded wire can be formed.

In the case where the stranded wire is coated with the coating material, since the stranded wire rotates in the coating material, the coating material sufficiently enters the concave portion of the spiral convex-concave portion formed on the surface of the stranded wire due to the thread function. As a result, the sufficiently coated stranded wire can be formed.

### BRIEF DESCRIPTION OF DRAWINGS

FIG. 1 is a front view illustrating a constitution of a stranding machine according to a first embodiment of the invention;

FIG. 2 is a diagram including a partial cross section illustrating a constitution of a rotating body according to the first embodiment of the invention;

FIG. 3 is a front view illustrating a constitution of the stranding machine according to a second embodiment of the invention; and

FIG. 4 is a front view illustrating a constitution of the stranding machine according to a third embodiment of the invention.

### BEST MODE FOR CARRYING OUT THE INVENTION

One embodiment of the present invention is described below with reference to the drawings. Members, constitutions, and arrangement described below does not limit the invention, and it goes without saying that they can be variously modified according to the gist of the invention.

### First Embodiment

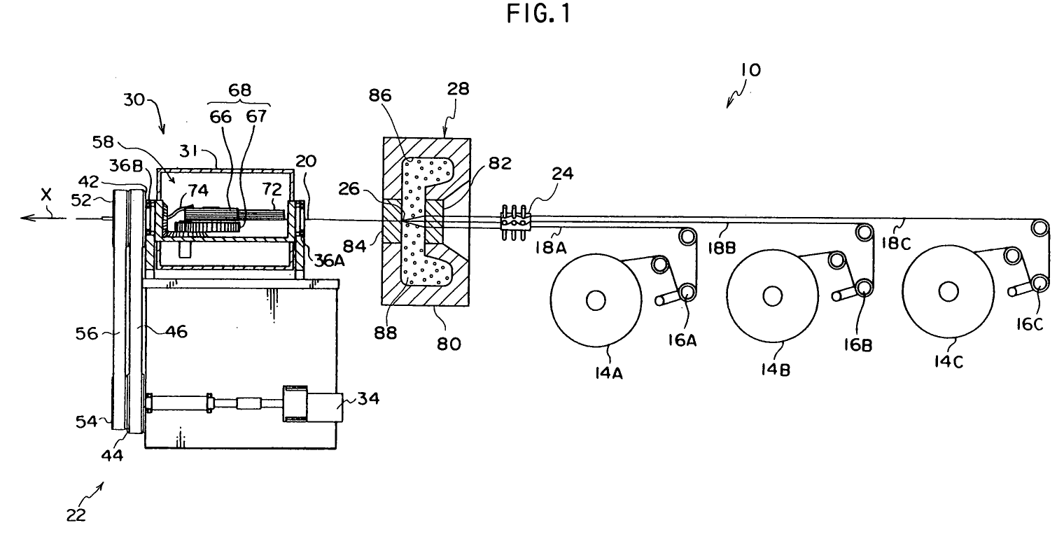

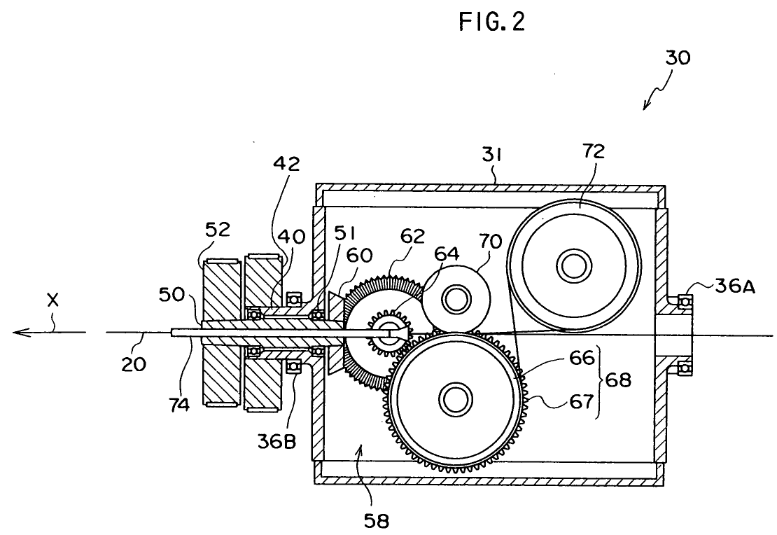

A constitution of a cord manufacturing line 10 according to a first embodiment of the invention is described with reference to FIGS. 1 and 2.

The cord manufacturing line 10 according to the first embodiment is suitably used for forming a stranded rubber-coated cord 20 composing a belt ply or a carcass ply of a tyre, for example. The cord manufacturing line 10 is provided with a plurality of bobbins 14A to 14C as a wire material holding unit around which wire materials 18A to 18C (for example, steel cords) are respectively wound, tension control sections 16A to 16C which control tensions of the wire materials 18A to 18C drawn from the bobbins 14A to 14C, and a stranding machine 22.

The stranding machine 22 is a drawing/rotating/rubber-coating integral type apparatus which strands the wire materials 18A to 18C to form a stranded wire and coats the stranded wire with rubber so as to manufacture a stranded rubber-coated cord 20. The stranding machine 22 includes a preforming section (shape forming section) 24 which preforms (forms a shape) the wire materials 18A to 18C, a rubber coating section 28 (extruding mold head) as a coating unit which coats a stranded wire arranged on a position apart from the plurality of bobbins 14A to 14C in a wire material drawing direction (X-direction) with rubber, a rotating body 30 as a stranded wire forming unit which is disposed in the wire material drawing direction (X-direction) of the rubber coating section 28, and a motor 34 which applies a rotating force to the rotating body 30 and applies a force for drawing the wire materials 18A to 18C wound around the bobbins 14A to 14C, respectively.

The rotating body 30 is disposed coaxially in line with the wire material drawing direction, and is held rotatably by bearing portions 36A and 36B provided to the stranding machine 22 so as to be capable of rotating about the wire material drawing direction (X-direction). As shown in FIGS. 1 and 2, a rotation driving pulley 42 is fixed to a rotation driving shaft portion 40 which protrudes from a housing 31 of the rotating body 30 into a short cylindrical shape on the wire material drawing direction (X-direction) side of the rotating body 30, and an endless belt 46 is stretched between the rotation driving pulley 42 and a first rotating plate 44 mounted to a shaft portion of the motor 34.

A drawing driving shaft member 50 having an elongated cylindrical shape is inserted into a rotational center of the rotation driving shaft portion 40. The drawing driving shaft member 50 is supported by a bearing portion 51 provided to the rotating body 30. A drawing driving pulley 52 which is fixed to the drawing driving shaft member 50 is provided on the wire material drawing direction (X-direction) side of the rotation driving pulley 42, and an endless belt 56 is stretched between the drawing driving pulley 52 and a second rotating plate 54 mounted to a shaft portion of the motor 34.

A drawing mechanism 58 as a wire material drawing unit which draws the stranded rubber-coated cord 20 is provided in a housing 31. The drawing mechanism 58 has a first gear 60 which is fixed coaxially with the drawing driving shaft member 50, and a second gear 62 which is engaged with the first gear 60. A small gear section 64 with small diameter is provided to a rotational center of the second gear 62. The drawing mechanism 58 has a multi-tiered winding capstan 68 which has a winding section 66 around which the stranded rubber-coated cord 20 is wound at several times and a large gear section 67 engaged with the small gear section 64, and a pinch roller 70 which touches the winding section 66 of the multi-tiered winding capstan 68 so as to pressurize the stranded rubber-coated cord 20 against the winding section 66.

In the first embodiment, the winding section 66 of the multi-tiered winding capstan 68 and the pinch roller 70 compose a smoothing unit which smoothes unvulcanized rubber on the surface of the stranded wire. The surface of the winding section 66 of the multi-tiered winding capstan 68 and the surface of the pinch roller 70 are composed of a smoothed surface. The drawing mechanism 58 has a multi-tiered winding dummy pulley 72 around which the stranded rubber-coated cord 20 wound around the multi-tiered capstan 68 is further wound at several times.

Diameters of the multi-tiered winding capstan 68 and the multi-tiered winding dummy pulley 72 are determined by taking the diameters and quality of the wire materials 18A to 18C into consideration so that when the stranded rubber-coated cord 20 delivered from the rotating body 30 is used, straightness is not influenced. The stranding machine 22 is provided with a cord discharge pipe guide 74 which is inserted into the rotational center of the drawing driving shaft member 50 and guides the stranded rubber-coated cord 20 delivered from the multi-tiered dummy pulley 72 to the wire material drawing direction of the rotating body 30.

In the first embodiment, the diameter of the first rotating plate 44 is slightly larger than the diameter of the second rotating plate 54, and a ratio of a rotating speed (stranding speed of the stranded wire) of the rotating body 30 to the drawing speed of the stranded rubber-coated cord 20 is adjusted. In the first embodiment, the rotation driving shaft portion 40 and the drawing driving shaft member 50 are disposed coaxially, and thus the constitution of the stranding machine 22 is simpler than a constitution where a drawing driving motor is further provided to the rotating body 30. In the stranding machine 22 according to the first embodiment, the drawing mechanism 58 is provided to the inside of the rotating body 30, so that the rotating body 30 and the drawing mechanism 58 are integral. As a result, the stranding machine 22 is made to be compact.

The rubber coating section 28 shown in FIG. 1 is composed of an extruding mold main body 80, a wire material introducing insert 82, and a die 84. The extruding mold main body 80 is formed with an extrusion chamber 86. Unvulcanized rubber 88 is compression-transported to the extrusion chamber 86 by a screw pump, not shown, so that an atmosphere filled with the compression-transported unvulcanized rubber 88 is formed. Insert holes, not shown, which are inserted into the wire materials 18A to 18C, respectively (namely, the total number of the insert holes is three) are formed on the wire material introducing insert 82 so as to be parallel with the wire material drawing direction (X-direction). Therefore, the wire materials 18A to 18C drawn via the preforming section 24 are led into the extrusion chamber 86 via the three insert holes formed on the wire material introducing insert 82, respectively. A delivery orifice (not shown) with an approximately three-leaf shape which is slightly larger than the cross section of the stranded rubber-coated cord 20 is formed on the die 84, and in the first embodiment, the stranded rubber-coated cord 20 is drawn through the delivery orifice.

A method of coating a stranded wire in the stranding machine 22 according to the first embodiment of the invention is described below.

In order to use the stranding machine 22, the motor 34 is rotated at a predetermined rotating speed with the wire materials 18A to 18C being set as shown in FIGS. 1 and 2. As a result, the first rotating plate 44 and the second rotating plate 54 rotate. When the first rotating plate 44 and the second rotating plate 54 rotate, their rotating forces are transmitted to the rotation driving pulley 42 and the drawing driving pulley 52 by the endless belts 46 and 56 so that the rotation driving pulley 42 and the drawing driving pulley 52 rotate.

When the drawing driving pulley 52 rotates, its rotating force is transmitted sequentially to the first gear 60, the second gear 62, and the multi-tiered winding capstan 68, so that the first gear 60, the second gear 52, and the multi-tiered winding capstan 68 rotate. As a result, the wire materials 18A to 18C are drawn from the bobbins 14A to 14C, respectively, at a predetermined drawing speed. The wire materials 18A to 18C drawn out of the bobbins 14A to 14C are preformed by the preforming section 24 so as to be led into the extrusion chamber 86 via the three insert holes formed on the wire material introducing inert 82 of the rubber coating section 28. The wire materials 18A to 18C introduced into the extrusion chamber 86 assemble towards the delivery orifice of the die 84 and are stranded in the delivery orifice of the die 84 so as to be a stranded wire. At this time, the unvulcanized rubber 88 fills between the wire material 18A to 18C introduced into the extrusion chamber 86, and the unvulcanized rubber 88 adheres to the surface of each of the wire materials 18A to 18C. In the first embodiment, the stranded wire is coated with rubber by the rubber coating section 28 so that the stranded rubber-coated cord 20 is formed.

The stranded rubber-coated cord 20 formed in such a manner is led to the rotating body 30 via the delivery orifice of the die 84, and is pushed against the winding section 66 of the multi-tiered winding capstan 68 in the rotating body 30 by the pinch roller 70. Thereafter, the stranded rubber-coated cord 20 is wound around the winding section 66 and then around the multi-tiered winding dummy pulley 72 at several times, so as to be delivered from the rotating body 30 to the outside via the cord discharge pipe guide 74.

A function and an effect of the method of coating a stranded wire with rubber in the stranding machine 22 according to the first embodiment of the invention is described below.

In the stranding machine 22 in the first embodiment, the rotating force about the wire material drawing direction (X-direction) is applied to the plurality of wire materials 18A to 18C drawn from the bobbins 14A to 14C by the rotation of the rotating body 30 disposed on the position apart from the bobbins 14A to 14C in the wire material drawing direction (X-direction), so that the stranded wire is formed. Therefore, in the stranding machine 22 of the first embodiment, the plurality of wire materials 18A to 18C does not rotate on the bobbin 14A to 14C side of the stranded point 26 of the plurality of wire materials 18A to 18C. As a result, when the plurality of wire materials 18A to 18C is coated with the unvulcanized rubber 88 by the rubber coating section 28 like the first embodiment, the plurality of wire materials 18A to 18C does not cross the inside of the atmosphere filled with the compression-transported unvulcanized rubber 88. For this reason, the unvulcanized rubber 88 sufficiently fills spaces between the plurality of wire materials 18A to 18C, and sufficiently adheres to the surface of each of the wire materials 18A to 18C. As a result, the stranded rubber-coated cord 20 which is sufficiently coated with rubber can be formed.

### Second Embodiment

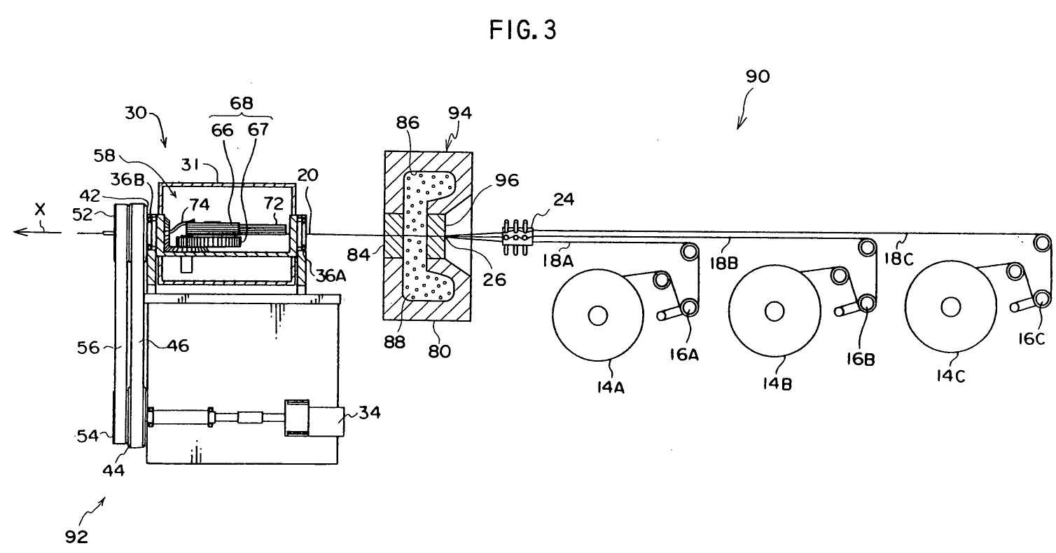

A constitution of the cord manufacturing line 90 according to a second embodiment of the invention is described below with reference to FIG. 3.

In the second embodiment of the invention, a difference from the first embodiment is a constitution of the wire material introducing insert 96 provided to the rubber coating section 94 of the stranding machine 92. Therefore, in the second embodiment of the invention, the same members as those in the first embodiment are denoted by the same reference numerals, and the description thereof will not be described.

In the rubber coating section 94 of the stranding machine 92 according to the second embodiment of the invention, an insert hole, not shown, into which the wire materials 18A to 18C are collectively inserted (namely, the number of the insert hole is one) is formed on the wire material introducing insert 96 so as to be parallel with the wire material drawing direction (X-direction). Therefore, the wire materials 18A to 18C drawn via the preforming section 24 assemble towards the one insert hole formed on the wire material introducing insert 96, and are stranded in this insert hole so as to be a stranded wire. The stranded wire introduced into the extrusion chamber 86 via the insert hole formed on the wire material introducing insert 96 is coated with rubber in the extrusion chamber 86. That is to say, the stranded wire rotates in the extrusion chamber 86, and is coated entirely with the rubber so that the unvulcanized rubber 88 enters a concave portion of a spiral convex-concave portion formed on the surface of the stranded wire due to the thread function. In the second embodiment, the stranded wire is coated with rubber by the rubber coating section 94 so that the stranded rubber-coated cord 20 is formed.

The stranded rubber-coated cord 20 formed in such a manner is led to the rotating body 30 through the delivery orifice of the die 84, and is pushed against the winding section 66 of the multi-tiered winding capstan 68 in the rotating body 30 by the pinch roller 70. Thereafter, the stranded rubber-coated cord 20 is wound around the winding section 66 and then wound around the multi-tiered winding dummy pulley 72 at several times, so as to be delivered from the rotating body 30 to the outside via the cord discharge pipe guide 74.

A function and an effect of the method of coating the stranded wire with rubber in the stranding machine 92 according to the second embodiment of the invention is described below.

In the stranding machine 92 of the second embodiment, the rotating force about the wire material drawing direction (X-direction) is applied to the plurality of wire materials 18A to 18C drawn from the bobbins 14A to 14C by the rotation of the rotating body 30 disposed on the position apart from the bobbins 14A to 14C in the wire material drawing direction (X-direction), so that a stranded wire is formed. Therefore, in the stranding machine 92 of the second embodiment, the stranded wire rotates on the rotating body 30 side of the stranded point 26 of the plurality of wire materials 18A to 18C. As a result, when the stranded wire is coated with the unvulcanized rubber 88 by the rubber coating section 94 like the second embodiment, since the stranded wire rotates in the atmosphere filled with the compression-transported unvulcanized rubber 88, the unvulcanized rubber 88 enters the concave portion of the spiral convex-concave portion formed on the surface of the stranded wire due to the thread function. As a result, the stranded rubber-coated cord 20 which is sufficiently coated with rubber can be formed.

In the second embodiment, the stranded rubber-coated cord 20 formed in the above manner is led to the rotating body 30, and is pushed against the winding section 66 of the multi-tiered winding capstan 68 by the pinch roller 70. Therefore, when the stranded rubber-coated cord 20 is pushed against the winding section 66 of the multi-tiered winding capstan 68 by the pinch roller 70, the unvulcanized rubber 88 on the surface of the stranded wire of the rubber-coated cord 20 is smoothed.

Therefore, because it is possible to smooth convexities, concavities, and coating irregularities in the unvulcanized rubber 88 on the surface of the stranded wire, the rubber-coated cord 20 sufficiently provided with coating material can be formed.

### Third Embodiment

The cord manufacturing line 100 according to a third embodiment of the invention is described below with reference to FIG. 4.

In the third embodiment of the invention, a difference from the first and second embodiments is a structure of a extruding mold main body 108 provided to the rubber coating section 104 of the stranding machine 102. Therefore, in the third embodiment of the invention, the same components as those in the first and second embodiments are denoted by the same reference numerals, and the description thereof will not be described.

In the rubber coating section 104 of the stranding machine 102 according to the third embodiment of the invention, the extruding mold main body 108 is provided with the wire material introducing insert 82, the die 84, and an intermediate die 1 10. The extruding mold main body 108 is formed with a first extrusion chamber 112 and a second extrusion chamber 114. The unvulcanized rubber 88 is compression-transported to the first extrusion chamber 112 and the second extrusion chamber 114 by a screw pump, not shown, for example, so that the atmosphere filled with the compression-transported unvulcanized rubber 88 is formed. The wire materials 18A to 18C drawn via the preforming section 24 are led into the first extrusion chamber 112 via the three insert holes formed on the wire material introducing insert 82. The wire materials 18A to 18C led into the extrusion chamber 86 assemble towards a delivery orifice of the intermediate die 110, and are stranded in the delivery orifice of the intermediate die 110 so as to become a stranded wire.

At this time, the unvulcanized rubber 88 fills between the wire materials 18A to 18C led into the first extrusion chamber 112, and adheres to the surface of each of the wire materials 18A to 18C. The stranded wire coated with rubber is led into the second extrusion chamber 114 via the intermediate die 110. The stranded wire led into the second extrusion chamber 114 is further coated with rubber in the second extrusion chamber 114. That is to say, in the second extrusion chamber 14, the stranded wire rotates, and the entire stranded wire is coated with rubber so that the unvulcanized rubber 88 enters the concave portion of the spiral convex-concave portion formed on the surface of the stranded wire due to the thread function.

In the third embodiment, the plurality of wire materials 18A to 18C positioned on the bobbins 14A to 14C side of the stranded point 26 are coated with rubber, and the plurality of wire materials 18A to 18C are stranded so as to be the stranded wire. Thereafter, the stranded wire is subsequently coated with rubber so that the stranded rubber-coated cord 20 is formed. As a result, the rubber-coated cord 20 which is sufficiently coated with rubber can be reliably formed.

### INDUSTRIAL APPLICABILITY

The present invention can form the stranded wire which is sufficiently coated with rubber as mentioned above, and its utilization range is very wide.

### DESCRIPTION OF REFERENCE NUMERALS

14A to 14C: bobbin (wire material holding unit)
18A to 18C: wire material (wire material)
22: stranding machine
28: rubber coating section (coating unit)
30: rotating body (stranded wire forming unit)
58: drawing mechanism (wire material drawing unit)
66: winding section (smoothing unit)
68: multi-tiered winding capstan (smoothing unit)
70: pinch roller (smoothing unit)
88: coating material (unvulcanized rubber)

1. A stranding machine, characterized by comprising:
a wire material drawing unit which draws a plurality of wire materials from a wire material holding unit which holds the plurality of wire materials;
a stranded wire forming unit which is disposed at a position apart from the wire material holding unit in a wire material drawing direction of the plurality of wire materials, and which rotates about the wire material drawing direction so as to apply a rotating force having a rotating axis in the wire material drawing direction of the plurality of wire materials, and which strands the plurality of wire materials so as to form a stranded wire; and
a coating unit which coats at least one of the plurality of wire materials positioned on the wire material holding unit side of a stranded point of the plurality of wire materials and the stranded wire positioned on a stranded wire rotating unit side of the stranded point.

2. The stranding machine of claim 1, characterized in that the wire material drawing unit is provided to the stranded wire forming unit.

3. The stranding machine of claim 1, characterized in that a smoothing unit which smoothes the coating material on the surface of the stranded wire is provided in the wire material drawing direction of the coating unit.

4. A method of coating a stranded wire, characterized in that a plurality of wire materials is drawn from a wire material holding unit which holds the plurality of wire material, and a rotating force, having a rotating axis in a wire material drawing direction, is applied to the plurality of wire materials, at a position apart from the wire material holding unit in the wire material drawing direction of the plurality of wire materials, and the plurality of wire materials is stranded so that a stranded wire is formed, wherein at least one of the plurality of wire materials positioned on the wire material holding unit side of a stranded point of the plurality of wire materials, and the stranded wire positioned on a side of the stranded point opposite to the wire material holding unit, is coated with a coating material.

5. The method of coating a stranded wire of claim 4, characterized in that after at least one of the plurality of wire materials positioned on the wire material holding unit side of the stranded point of the plurality of wire materials, and the stranded wire positioned on the side of the stranded point opposite to the wire material holding unit, is coated with the coating material, the coating material on the surface of the stranded wire is smoothed.

6. The stranding machine of claim 2, characterized in that a smoothing unit which smoothes the coating material on the surface of the stranded wire is provided in the wire material drawing direction of the coating unit.
